(19) United States
(12) Patent Application Publication
(10) Pub. No.: US 2010/0026988 A1
(43) Pub. Date: Feb. 4, 2010

(54) ONLINE SENSOR FOR MONITORING CHEMICAL CONTAMINATIONS IN HYDRAULIC FLUIDS

(76) Inventors: Francois Cros, Toulouse (FR); Wilhelm Ficker, Poring (DE); Delphine Hertens, Toulouse (FR); Angelika Krenkow, Munich (DE); Wolfgang Legner, Hohenkichen-Siegertsbrunn (DE); Gerhard Muller, Grafing (DE); Thomas Ziemann, Innin am Holz (DE); Dominique Van den Bossche, Mones (FR)

Correspondence Address: ZIOLKOWSKI PATENT SOLUTIONS GROUP, SC (ZPS), 136 S WISCONSIN ST, PORT WASHINGTON, WI, 53074, US

(21) Appl. No.: 12/518,775

(22) PCT Filed: Dec. 15, 2007
(86) PCT No.: PCT/DE2007/002258

§ 371 Date: Aug. 21, 2009

(30) Foreign Application Priority Data
Dec. 18, 2006 (DE) 10 2006 060 138.6

(51) Int. Cl. G01J 3/00; G01J 5/02

(52) U.S. Cl. 356/51; 250/339.07

(57) ABSTRACT

An online sensor for monitoring chemical contaminations in hydraulic fluids, having a receiving device for the fluid to be monitored, the device having observations windows disposed on two opposite sides, is characterized in that the online sensor has an IR emitter and an IR detector comprising at least two, preferably four detector fields for IR spectroscopy, wherein the fields are disposed opposite of each other on both observations windows. This provides a sensor that is capable of detecting the maintenance-relevant parameters of hydraulic fluids based on phosphate esters online, which is to say without having to withdraw the same from the airplane's hydraulic system and remove the same as a sample.

### BACKGROUND OF THE INVENTION

The present invention relates to an online sensor for monitoring chemical contaminations in hydraulic fluids according to the preamble of claim 1.

Hydraulic fluids for aviation are generally hygroscopic. From this it follows that their lifetime is to a high degree unpredictable. Since the overall hydraulics of an aircraft is influenced by the state of the hydraulic fluid, the unnoticed degeneration of the hydraulic fluid has serious consequences which can range from damage as far as total loss. The methods used so far in aviation for determining the state of the hydraulic fluid in the hydraulic system of an aircraft are tedious, time-consuming and expensive. Thus, the hydraulic fluid is usually not investigated more frequently than once a year. This carries a high risk with considerable costs if the lifetime of the hydraulic fluid ends not according to schedule and the airline operations must therefore be interrupted.

At the present time, the hydraulic fluid is usually investigated “off line”, i.e. after sampling in a laboratory. For this, hydraulic fluid must be tapped off from the system at the maintenance support point and sent to a specialised laboratory for analysis there. Maintenance work can then only take after a waiting time of several days after the result has arrived back from the laboratory.

The parameters of the hydraulic fluid of interest in this case are particularly the acid content since this critical parameter defines the lifetime. In particular, corrosion of the hydraulic system, i.e. of pumps, valves and pipes, is promoted by too-high acid content. The acid content is designated by the neutralisation number TAN. Furthermore, the water dissolved in the hydraulic fluid is an important parameter which reduces the lifetime by hydrolysis. In addition, free water can destroy and freeze the pumps due to lack of lubrication which can result in a blockage. Another important parameter is the gases dissolved in the hydraulic fluid which can form bubbles in the case of a pressure drop in the system and lead to a loss of the transmission force of the hydraulic fluid. Another decisive parameter is the chlorine content since chlorine solutions can lead to corrosion of system components of the hydraulic system. In addition, undesirable electrochemical reactions can occur as a result. Finally, the electrical properties, i.e. the electrical conductivity and the electrical resistance are parameters which reflect the multiple fluctuations of the hydraulic fluid.

The importance of these parameters originates from the fact that phosphate esters such as occur in hydraulic fluids for aviation are polar and therefore tend to absorb water. Dissolved water in turn can result in the disintegration of phosphate ester molecules which takes place along three reaction paths: oxidation, pyrolysis and hydrolyis. The additives form weak acids according to the following equation:

Ester+H₂O->alcohol+—COOH

The phosphate esters form strong acids according to the following equation:

H₂O->alcohol+H₃PO₄

The production of alcohol can ultimately lead to the formation of bubbles, which can adversely affect the force transmission properties of the hydraulic fluid. On the other hand phosphoric acid molecules can react with dissolved water and produce H₃O⁺ ions which induce corrosion.

For the aforesaid reasons, the online monitoring and observation of the variation in the relevant parameters of a hydraulic fluid is of major importance for aircraft.

Monitoring systems for observing the variation of the state of hydraulic fluids are known from the prior art. Thus, U.S. Pat. No. 5,071,527 describes a sensor which has electrodes for measuring the electrical properties of a sample of the hydraulic fluid to be observed. This sensor is connected to an evaluation unit which assigns the results of the electrical conductivity measurement to specified states of the hydraulic fluid. In this case, the sensor unit is small in such a manner that it can be used both off-line and online. However, the resistance measurement alone yields only inaccurate and overall unsatisfactory results so that additional laboratory investigations must also be used here.

Furthermore, U.S. Pat. No. 4,013,953 describes an optical sensor for monitoring the state of hydraulic fluids whose measurement in particular is based on the attenuation and scattering of the visible light beam passed through a sample of the hydraulic fluid to be monitored. The sensor unit described here has a very complex structure and as a result of the moving parts contained therein, is itself very maintenance-sensitive. Since the sensor unit described has a weight of about 1 kg, off-line use primarily comes to the fore.

### BRIEF DESCRIPTION OF THE INVENTION

It is therefore the object of the present invention to provide a sensor which is capable of determining online the maintenance-relevant parameters of hydraulic fluids based on phosphate esters, i.e. without withdrawing these from the aircraft hydraulic system and removing these as samples. In particular, information about the water fraction dissolved in the hydraulic fluid and about the neutralisation number TAN (total acid number) should be obtained by this means.

This object is achieved by the features of claim 1. Advantageous further developments and embodiments of the invention are specified in the dependent claims.

The online sensor according to the invention for monitoring chemical contaminations in hydraulic fluids comprising a receiving unit for the fluid to be monitored which has observation windows disposed on two opposite sides is characterised in that the sensor has an IR (infrared) emitter and an IR detector having at least two, preferably four detector fields for IR spectroscopy which are disposed opposite to one another on the two observation windows.

By this means, a sensor is provided which is capable of determining online the maintenance-relevant parameters of hydraulic fluids based on phosphate esters, i.e. without withdrawing these from the aircraft hydraulic system and removing these as samples. In particular, with the online sensor according to the invention, information can be obtained about the water fraction dissolved in the hydraulic fluid and about the neutralisation number TAN (total acid number).

It was discovered in experiments that the absorption of IR radiation on passing through phosphate-ester-based hydraulic fluid gives an exact indication of the state of the hydraulic fluid as a result of the vibrations of the O—H molecules in pre-determined IR transmission bands. Thus, the absorption of the IR radiation at a specified wave number varies in a defined manner according to whether contaminations due to water, alcohol or acid are present. The percentage fraction of contamination can also be determined in this manner. Furthermore, the neutralisation number TAN can be determined by this means.

As a result of the small size and low weight of the online sensor according to the invention, the measurement can be made online, i.e. in the hydraulic system during flight of the aircraft and repeated at any time intervals, for example, daily. The exact state of the hydraulic fluid and a corresponding trend can be determined by reference to the data thus obtained and maintenance works can be planned strategically, for example, together with other envisaged maintenance work.

An advantageous embodiment of the online sensor according to the invention provides that an optical filter having at least two, preferably four fields for IR transmission bands with different wave numbers is provided between the one observation window and the IR detector. By this means, a purely optically based qualitative and quantitative evaluation of the measurement results is possible.

An advantageous embodiment of the online sensor according to the invention provides that the observation window is made of sapphire glass. This makes it possible to achieve scatter-free passage of radiation through the sample of the hydraulic fluid.

An advantageous embodiment of the online sensor according to the invention provides that devices for online evaluation of the electrical measurement signals of the IR detector are provided. These devices can have a processor unit and a memory unit.

An advantageous embodiment of the online sensor according to the invention provides that a correlation between the IR transmittance at at least two predetermined wave numbers and the water content and/or the alcohol content in the hydraulic fluid is stored in the device for online evaluation. These data are determined preliminarily in experiments and are stored in the memory unit of the device for online evaluation.

An advantageous embodiment of the online sensor according to the invention provides that a correlation between the IR transmittance at at least two predetermined wave numbers and the neutralisation number TAN is stored in the device for online evaluation. These data are determined preliminarily in experiments and are stored in the memory unit of the device for online evaluation.

An advantageous embodiment of the online sensor according to the invention provides that the optical filter has at least one field for IR transmission bands having a wave number between 3300 cm⁻¹ and 3600 cm⁻¹, preferably having a wave number of 3500 cm⁻¹. These transmission bands are particularly suitable for determining the asymmetry of the O—H absorption peaks in phosphate-ester-based hydraulic fluids.

An advantageous embodiment of the online sensor according to the invention provides that measuring devices are provided for measuring the passage of light in the visible range, preferably at 400 nm. This improves the validity of the IR measurement in the strong oxidation range. In this case, a structure having a light emitter and a light detector, for example, a photodiode, is feasible.

An advantageous embodiment of the online sensor according to the invention provides that devices are provided for measuring the temperature of the fluid. In this case, a corresponding temperature sensor can be implemented, for example, as a thermocouple.

An advantageous embodiment of the online sensor according to the invention provides that devices are provided for measuring the electrical conductivity of the fluid. This can be accomplished by means of two electrodes. Water and acid content of the hydraulic fluid can likewise be determined by measuring the conductivity. This can be used to verify the IR measurement results.

Further measures which improve the invention are specified in the dependent claims or are described in detail hereinafter together with the description of a preferred exemplary embodiment of the invention with reference to the figures.

### BRIEF DESCRIPTION OF THE DRAWINGS

In the figures:

FIG. 1 shows a schematic view of an advantageous embodiment of an online sensor according to the invention;

FIG. 2 shows a view of the emitter from FIG. 1 along the line II-II;

FIG. 3 shows a view of the detector from FIG. 1 along the line III-III; and

FIG. 4 shows a diagram showing the IR transmittance at different wave numbers.

The figures shown are purely schematic as examples and not to scale. The same or similar components are provided with the same reference numerals. In the diagrams the electrical and hydraulic incoming and outgoing lines were omitted for reasons of clarity.

### DETAILED DESCRIPTION OF THE PREFERRED EMBODIMENT

FIG. 1 shows a schematic view of an advantageous embodiment of a sensor 1 according to the invention which is designed to be substantially cylindrical and substantially comprises three assemblies. The centrally disposed assembly comprises a sample holder 4 for receiving a sample of the hydraulic fluid to be monitored. The sample merely comprises a few cm³ of the hydraulic fluid. The sample container 4 comprises a thin disk-shaped aluminium container which is bordered on both front sides by observation windows 3 made of sapphire glass. Annular electrodes 7 are disposed on both externally directed sides of the observation window 3. Furthermore, a temperature sensor 8 which is configured as a thermocouple in the present case, is disposed in the lower area of the sample container 4.

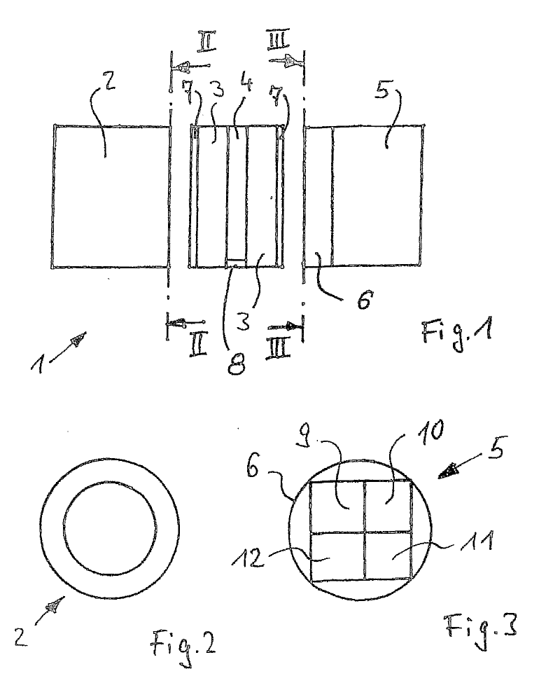

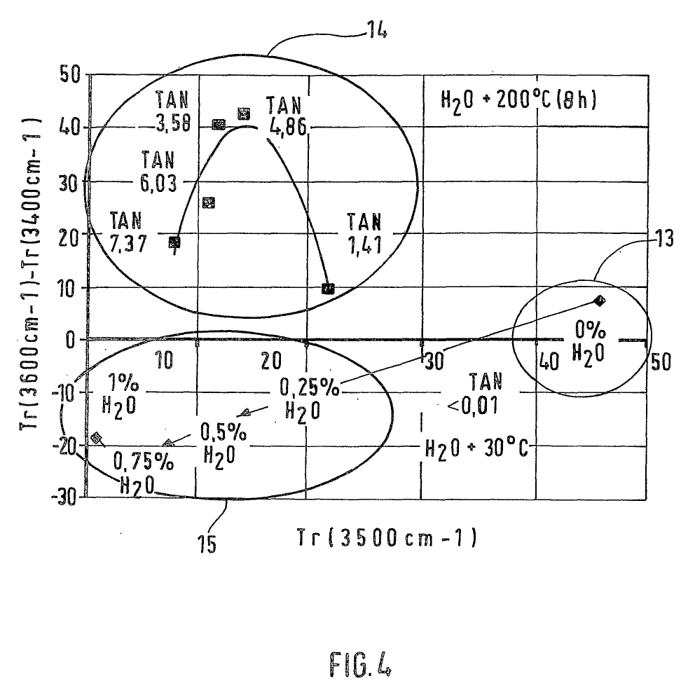

Located in the plane of the drawing to the left of the sample container 4 is an IR emitter 2 which is shown in FIG. 2 as a view along the line II-II in FIG. 1. The IR emitter 2 in this case is a micro-machined thermal IR emitter. Shown on the right of the sample container 4 in the plane of the drawing is a cylindrical IR detector 5 comprising four detector fields as can also be deduced from the view in FIG. 3. In the present exemplary embodiment, the IR detector 5 is configured as a thermal infrared detector, for example, as a bolometer or as a thermistor. The use of a special CCD element is also feasible.

Located between the IR detector 5 and the sample container 4 is an optical filter 6 having four fields each having a different IR transmission band. The four fields of the filter 6 are arranged in the clockwise direction, comprising a field 9 as reference field, a field 10 for the wave number 3500 cm⁻¹, a field 11 for the wave number 3600 cm⁻¹ and a field 12 for the wave number 3400 cm⁻¹.

The length of the optical beam path inside the hydraulic fluid is in this case determined by the distance of the two infrared-transmitting observation windows 3. In the exemplary embodiment this is 0.3 mm.

On account of the small size and the low weight of the online sensor, this can be integrated directly in the hydraulic system of an aircraft, for example, in the pipes. For online measurement, i.e. for measurement in situ during airline operation, the infrared beam from the IR emitter 2 is passed through the observation window 3 and the sample of hydraulic fluid present in the sample container 4 and after passing through the filter 6 having the four transmission bands 9, 10, 11, 12 is received by the IR detector 5. In this case, the wavelength of the emitted IR radiation in the present exemplary embodiment is between 3000 nm and 4000 nm.

The measurement signals, i.e. the absorption of radiation are converted in the IR detector and relayed as electrical signals to a device (not shown) for online evaluation. This device substantially comprises a processor unit and a data memory. By comparing the current measurement results with stored data, it can immediately be determined whether the state of the hydraulic fluid is moving within a healthy range or whether the water fraction is too high or acid formation is present.

Additionally disposed in the online sensor 1 shown in FIGS. 1 to 3 are two electrodes 7 which are used for a conductivity measurement in order to verify the values determined by the IR measurement. In this case, the electrodes are designed as platinum electrodes and printed on a ceramic substrate. In order to avoid polarisation effects, the electrodes are exposed to an alternating voltage having a frequency of 1 kHz. The temperature measurement using the temperature sensor 8 can also serve as verification of the IR measurement results and confirm the functional efficiency of the IR sensors.

This IR spectrography evaluation can be represented graphically, for example, in a diagram according to FIG. 4. In this diagram the IR transmittance in percent for the IR transmission band having the wave number 3500 cm⁻¹ is plotted on the abscissa and identified by Tr (3500 cm⁻¹). The IR transmittances in percent for the IR transmission bands at the wave numbers 3600 cm⁻¹ and 3400 cm⁻¹ are plotted on the ordinate and identified with Tr(3600 cm⁻¹)-Tr(3400 cm⁻¹). The diagram takes account of the asymmetries in the three different transmission bands and makes it possible to determine whether the state of the hydraulic fluid is located in a “healthy” region 13, an “unhealthy” acid region 14 or in an “unhealthy” region with water absorption 15. The present invention is not restricted in its embodiment to the previously specified preferred exemplary embodiment. Rather, a number of variants are feasible which make use of the solution presented even in fundamentally different types of embodiments.

What is claimed is:

1. An online sensor for monitoring chemical contaminations in hydraulic fluids comprising a receiving unit for the fluid to be monitored, which has observation windows disposed on two opposite sides, characterised in that the online sensor has an IR emitter and an IR detector having at least two, preferably four detector fields for IR spectroscopy which are disposed opposite to one another on both of the two observation windows.

2. The online sensor according to claim 1, characterised in that an optical filter having at least two, preferably four fields for IR transmission bands with different wave numbers is provided between the one observation window and the IR detector.

3. The online sensor according to claim 1, characterised in that the observation window is made of sapphire glass.

4. The online sensor according to claim 1, characterised in that devices for online evaluation of the electrical measurement signals of the IR detector are provided.

5. The online sensor according to claim 4, characterised in that a correlation between the IR transmittance at at least two predetermined wave numbers and the water content and/or the alcohol content in the hydraulic fluid is stored in the device for online evaluation.

6. The online sensor according to claim 4, characterised in that a correlation between the IR transmittance at at least two predetermined wave numbers and the neutralisation number TAN is stored in the device for online evaluation.

7. The online sensor according to claim 1, characterised in that the optical filter has at least one field for IR transmission bands having a wave number between 3300 cm⁻¹ and 3600 cm⁻¹, preferably having a wave number of 3500 cm⁻¹.

8. The online sensor according to claim 1, characterised in that measuring devices are provided for measuring the passage of light in the visible range, preferably at 400 nm.

9. The online sensor according to claim 1, characterised in that devices are provided for measuring the temperature of the hydraulic fluid.

10. The online sensor according to claim 1, characterised in that devices are provided for measuring the electrical conductivity of the hydraulic fluid.
